(19) United States
(12) Patent Application Publication
(10) Pub. No.: US 2003/0135424 A1
(43) Pub. Date: Jul. 17, 2003

(54) System and method for automatically updating media in a digital jukebox

(76) Inventors: Jeffrey S. Davis, Seattle, WA (US); Erik E. Chelstad, Seattle, WA (US); Scott K. James, Seattle, WA (US); Stephan L. Poole, Seattle, WA (US)

Correspondence Address: Michael S. Smith, BLACK LOWE & GRAHAM PLLC, 816 Second Avenue, Seattle, WA, 98104, US

(21) Appl. No.: 10/051,439

(22) Filed: Jan. 17, 2002

(51) Int. Cl. H04N 7/16; G06F 17/60

(52) U.S. Cl. 705/26; 707/104.1; 725/1; 725/109

(57) ABSTRACT

A system and method are provided for automatically updating a distribution list for each of a plurality of digital jukeboxes located at a venue. The method includes receiving at a server connected to the plurality of digital jukeboxes over a network feedback information from each of the plurality of digital jukeboxes, and automatically updating a distribution list previously stored at the server for each of the plurality of jukeboxes based on the received song play information. The received feedback information includes a value for each song stored in the jukeboxes. The values for each song are determined according to jukebox events. The jukebox events include songs played by the same user, songs played on the same jukebox at any given time, songs deleted by the venue owner or jukebox operator, and songs in the top ten of the venue where the jukebox is located.

### PRIORITY CLAIM

This application claims priority from Provisional Patent Application filed pro se on Jan. 17, 2001, entitled “The Evolutionary Digital Jukebox” and bearing a serial number to be provided in a preliminary amendment as soon as the serial number can be retrieved.

### FIELD OF THE INVENTION

This invention relates generally to jukeboxes and, more specifically, to digital jukeboxes.

### BACKGROUND OF THE INVENTION

Present compact disc (CD) jukeboxes provide a greater selection of music than previous vinyl disc jukeboxes. Like older jukeboxes, the updating of a CD jukebox requires someone with mechanical knowledge of the jukebox to extract and replace the CDs that exist within the jukebox. This updating is a time consuming process that requires a service call to a technician. Also, the operator or venue owner must determine what type of new music to place into the jukebox and what music in the jukebox to remove. This task can become overwhelming to many operators or venue owners, because the jukebox may include hundreds of CDs.

Digital jukeboxes have recently been developed in order to provide a more efficient means for updating music that can be played. The digital jukebox is coupled to a server and database over a public or private data network. The digital jukebox stores digital music files that are retrieved from the database by the server. Thus, the digital jukebox does not require a technician to visit each jukebox and remove and ad CDs. However, the jukebox operator or venue owner must still make selections as to what new music to have entered into the digital jukebox and what music to have removed from the digital jukebox. Because some digital jukeboxes allow access to thousands of songs and hundreds of artist albums, the task of selecting and deleting music for a jukebox becomes very time consuming.

Therefore, there exists a need to reduce the burden of music selection presently experienced by digital jukebox operators and venue owners as well as making a more user-friendly interactive experience for the audience member.

### SUMMARY OF THE INVENTION

The present invention provides a method and system for automatically updating music in a digital jukebox from a remote location.

The present invention comprises a system and method for automatically updating a distribution list for each of a plurality of digital jukeboxes located at a venue. The method includes receiving at a server connected to the plurality of digital jukeboxes over a network feedback information from each of the plurality of digital jukeboxes, and automatically updating a distribution list previously stored at the server for each of the plurality of jukeboxes based on the received song play information.

In accordance with further aspects of the invention, the received feedback information includes a value for each song stored in the jukeboxes. The values for each song are determined according to jukebox events. The jukebox events include songs played by the same user, songs played on the same jukebox at any given time, songs deleted by the venue owner or jukebox operator, and songs in the top ten of the venue where the jukebox is located.

In accordance with other aspects of the invention, the received feedback information includes a value for each artist that has music stored in the jukeboxes. The values for each artist are determined according to jukebox events. The jukebox events include artists played by the same user, artists played on the same jukebox at any given time but not by the same user, artists deleted by at least one of the venue owner or jukebox operator, artists in the top ten of the venue where the jukebox is located, artists that play shows together, and artists appearing on compilation albums.

### BRIEF DESCRIPTION OF THE DRAWINGS

The preferred and alternative embodiments of the present invention are described in detail below with reference to the following drawings.

FIG. 1 is an example system diagram of the present invention;

FIG. 2 is a block diagram of the components of a jukebox;

FIG. 3 is a flow diagram of an example process performed by the system shown in FIG. 1;

FIGS. 4-7 are song/artist connection diagrams; and

FIGS. 8-13 are web page screen shots presented to an artist/label.

### DETAILED DESCRIPTION OF THE INVENTION

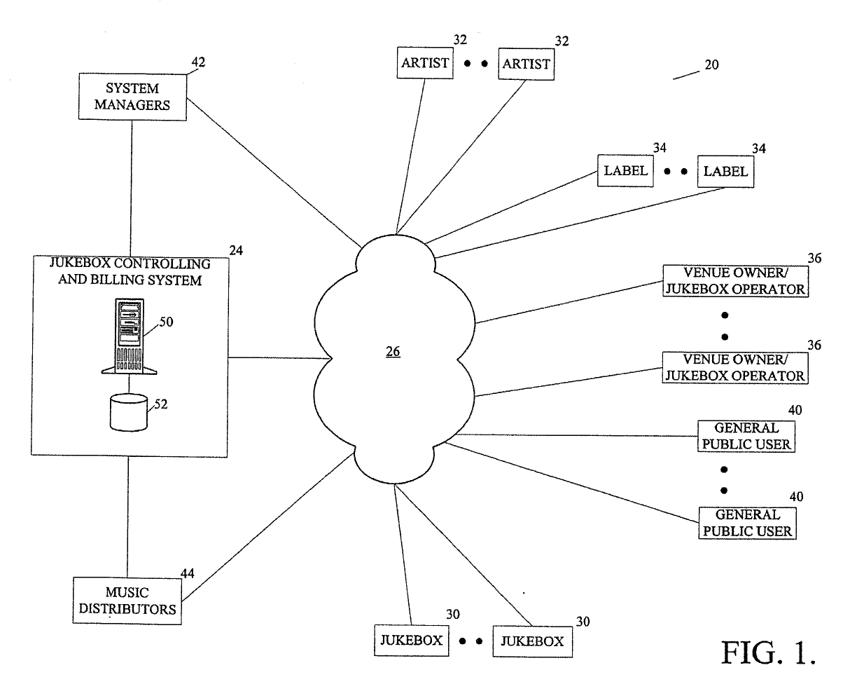

FIG. 1 illustrates an example system 20 of the present invention. The system 20 includes a jukebox controlling and billing system 24 that is coupled to a public (Internet) or private data network 26 and a plurality of jukeboxes 30. A plurality of artists 32, labels 34, venue owners/jukebox operators 36, and general public users 40 are coupled to the jukebox controlling and billing system 24 through the network 26. The system 20 also includes system managers 42 and music distributors 44 that are preferably coupled to the jukebox controlling and billing system 24 via a direct connection (such as direct modem dial-up) or a private network. The jukeboxes 30, system managers 42, and music distributors 44 can alternately be connected through the public data network 26 to the jukebox controlling and billing system 24.

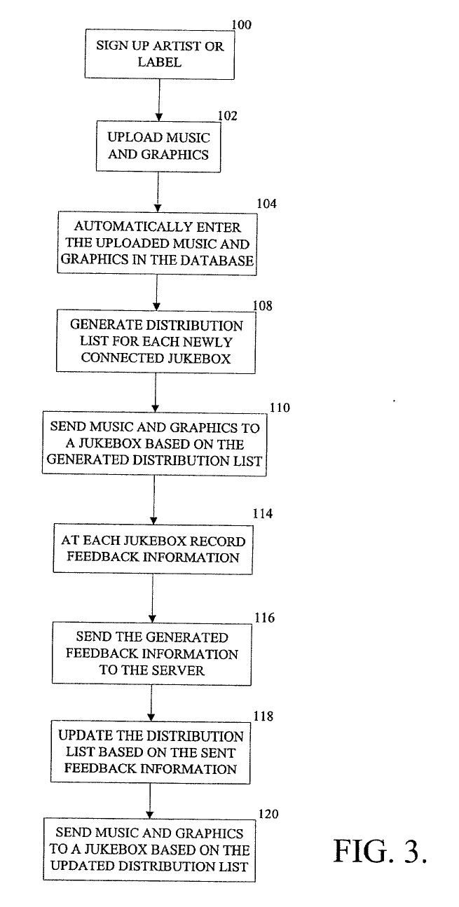

The jukebox controlling and billing system 24 includes a server 50 coupled to a database 52. The server 50 executes software components for allowing the artists 32 and labels 34 to make their music available for the jukeboxes 30 by storing the music in a central repository within the database 52. The server 50 also includes software components for automatically updating play lists or distribution lists for each jukebox 30 connected to the jukebox controlling and billing system 24. An example method for uploading music and graphics, and updating distribution lists for jukeboxes is illustrated below by example in FIGS. 3-7 and in a graphical user interface shown in FIGS. 8-13.

The jukebox controlling and billing system 24 allows the public to access artist information stored in the database 52, but preferably does not allow the general public to listen to stored music. The jukebox controlling and billing system 24 also allows the public to purchase desired music through the music distributor 44. After a user has listened to music at the jukebox and determined that the user would like to purchase that music, the user can access the jukebox controlling and billing system 24 using a general purpose computer with an Internet link and request to purchase the desired music. In one embodiment, the purchase request is forwarded to the music distributor 44 that completes the order.

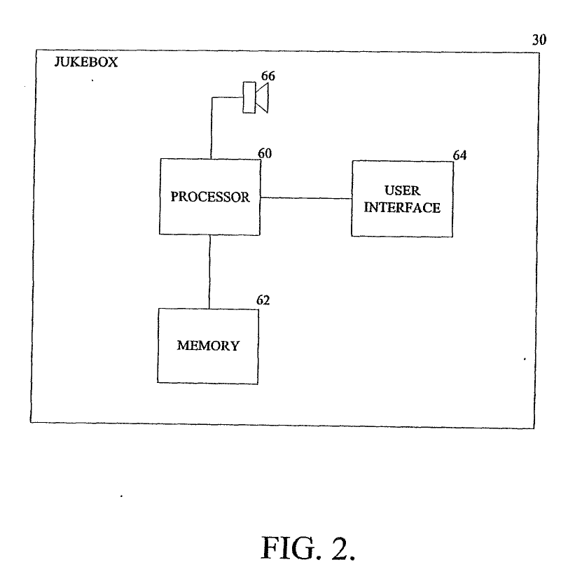

As shown in FIG. 2, the jukebox 30 includes a processor 60 coupled to local memory 62, a user interface 64 and an audio system 66. The processor 60 stores music and graphics files, received from the jukebox controlling and billing system 24, in the local memory 62. The processor 60 generates an interactive image on a display of the user interface 64, based on the stored music and graphics file. After a user enters money in a money receiving device that is part of the user interface 64, the user selects music files from the interactive image by manipulation of other components of the user interface 64, such as buttons, dials, and switches. The processor 60 records user music file selections according to a number of different parameters. Example parameters are described in more detail below. The recorded selections are sent to the jukebox controlling and billing system 24 for use in generating music file distribution lists and determining artist compensation. The selected music file is played through the audio system 66. As can be readily appreciated to one of ordinary skill in the art, the processor 60 and audio system 66 can be of the type purchased over the counter. Example embodiments of the jukebox 30 and the user interface 64 are described in a copending application filed concurrently herewith and bearing attorney docket number EFFF-1-1002.

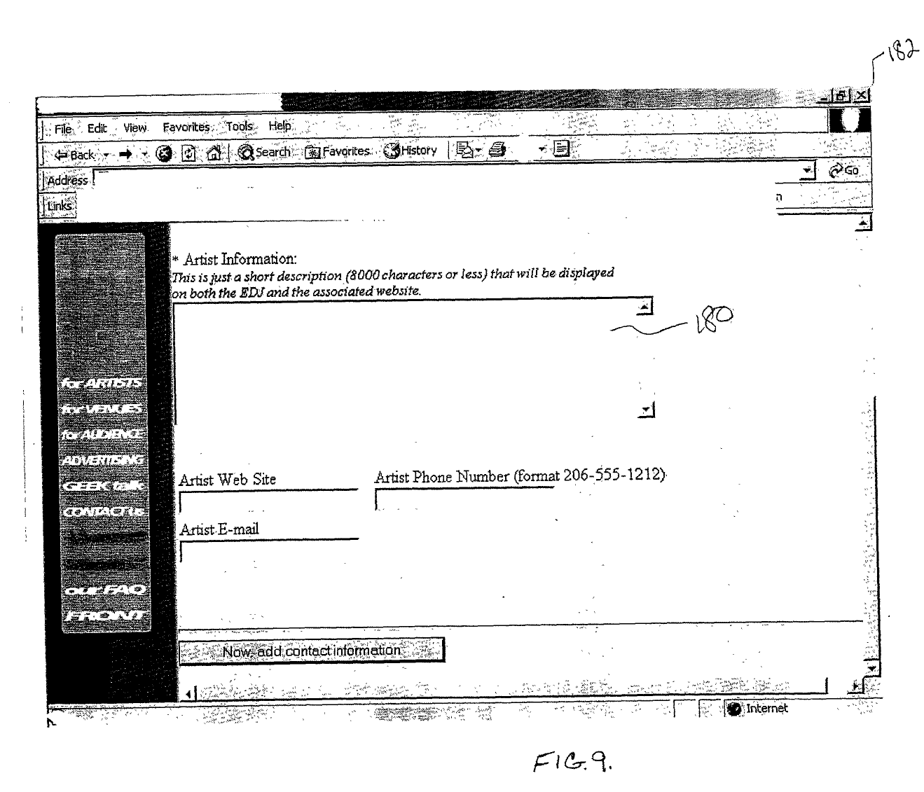

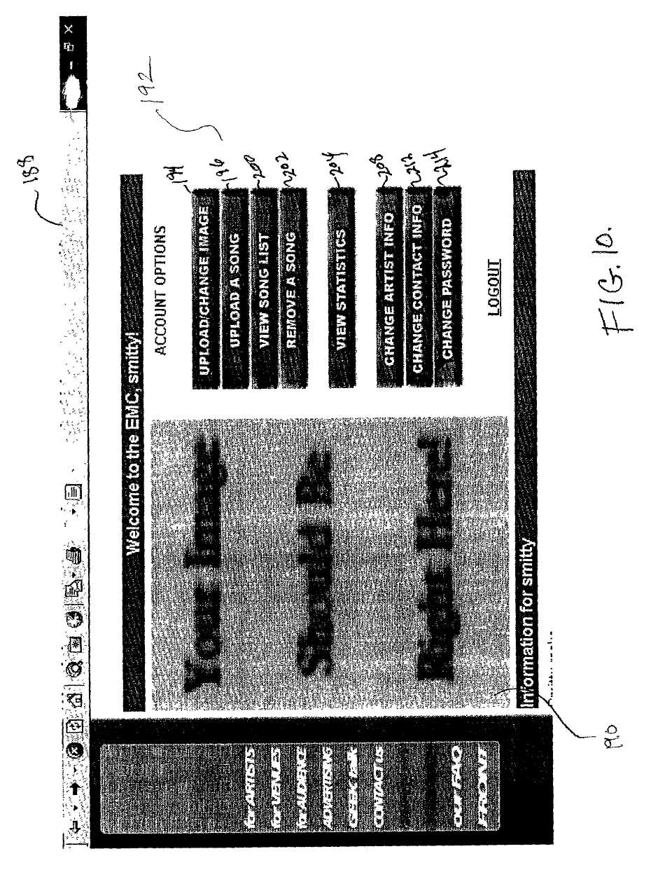

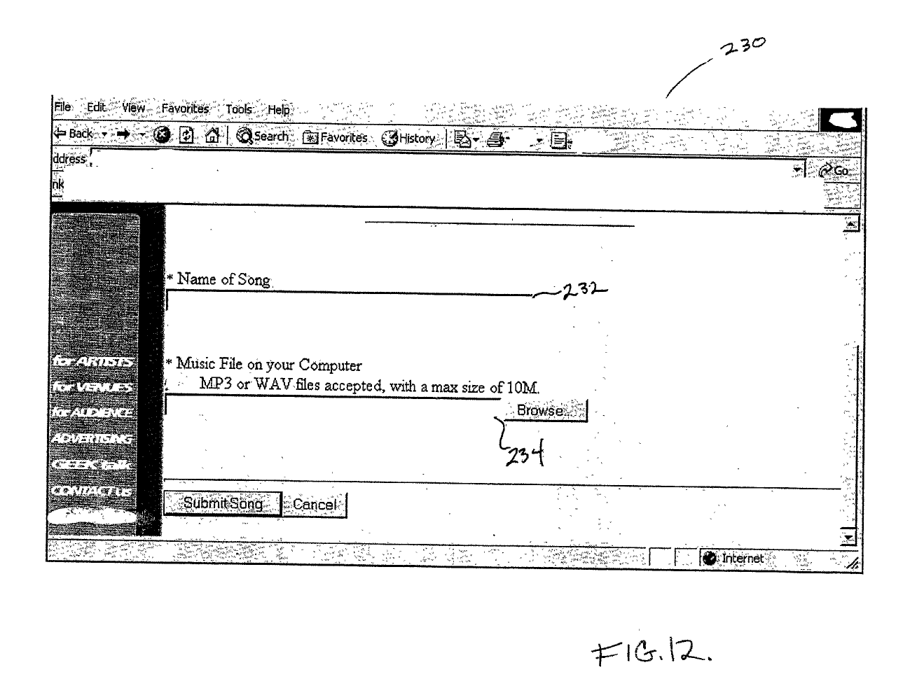

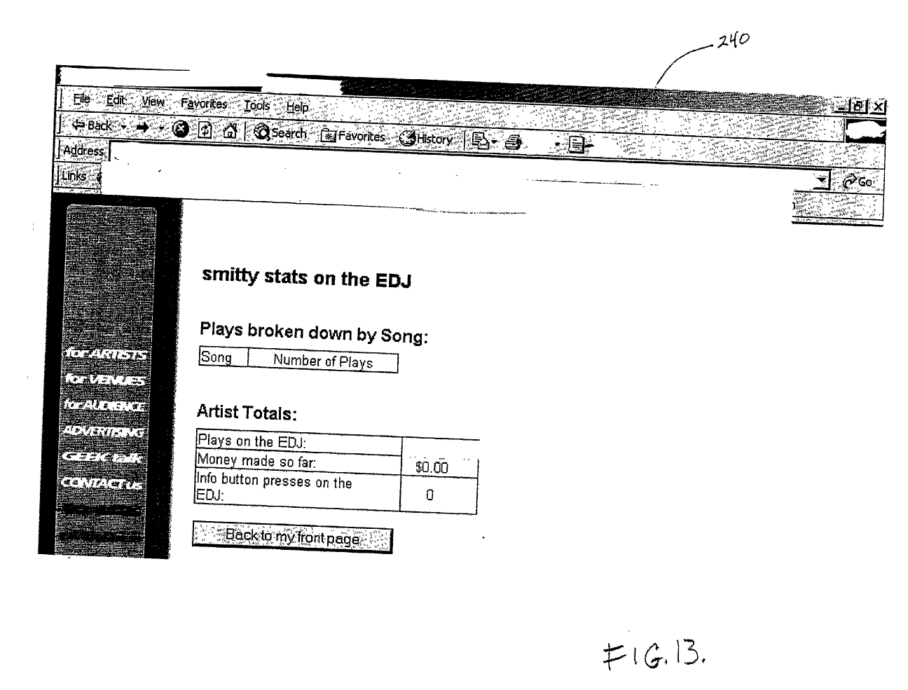

FIG. 3 illustrates a flow diagram that illustrates an example process by which the server 50 receives music and distributes the music for play on jukeboxes 30. First, at block 100, an artist 32 or label 34 signs up to receive the service provided by the jukebox controlling and billing system 24. The sign up process is preferably performed by an artist 32 or label 34 entering information onto a web page that is generated by an application program running the server 50 and accessible over the network 26. Example screen shots of web pages that allow artists 32 or labels 34 to sign up with the service are illustrated in FIGS. 8 and 9 below. Next, at block 102, the artist 32 or the label 34 uploads their music and associated graphics. FIGS. 11 and 12 illustrate example screenshots for uploading music and graphics. Examples of acceptable digital music formats include, but are not limited to, MP3 and WAV. Examples of acceptable graphics formats include, but are not limited to, JPEG, GIF, and MPEG. At block 104, the application program automatically enters the uploaded music and graphics in the database 52. Once the music and graphics are stored in the database, the server 50 makes the uploaded music and graphics available for entry into jukeboxes via jukebox distribution lists.

At block 108, the jukeboxes 30 are connected to the jukebox controlling and billing system 24 for the first time. At block 108, the server 50 includes a distribution list application program that generates distribution lists for each newly connected jukebox. A distribution list is a play list for a jukebox 30. The distribution list identifies the songs that are stored at a jukebox 30 or songs that are to be stored at a jukebox 30. Factors given by way of non-limiting example that are included in the generation of a distribution list for a newly connected jukebox include the type of venue where the jukebox 30 is located, venue owner or jukebox operator preferences, and a default distribution list. The server 50 saves the distribution list for each jukebox connected to the jukebox controlling and billing system 24. Next, at block 110, the server 50 sends music and graphics to the newly connected jukebox based on the generated distribution list. Music and graphic files can also be manually inserted into a jukebox.

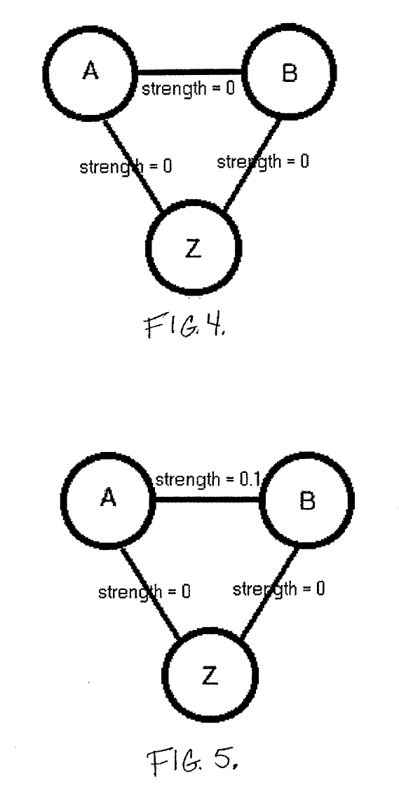

At block 114, operation or feedback information of that jukebox is recorded by the jukebox processor 60. The feedback information preferably includes the number of times a song was played, what songs were played by the same user (i.e., group of selections associated with a monetary event (e.g. 2 plays per $1)), what songs were played within a certain time period but not by the same user, what songs the venue owner or jukebox operator deleted, and what songs were not played in a period of time, such as a day. The feedback information is constantly being recorded and saved in local memory 62 of the jukebox 30. Upon a direct request from the jukebox controlling and billing system 24, or automatically at a predefined time, the generated feedback information is sent to the server 50 (see block 116). After the server 50 either pulls the feedback information from a jukebox 30 or the feedback information is pushed to the server 50, the distribution list application program running in the server 50 updates the distribution list associated with the jukebox that sent the feedback information. The update is based on the sent feedback information from a plurality of jukeboxes (see block 118). Then, at block 120, the server 50 sends music and graphics to the jukebox based on the updated associated distribution list. An example of updating the distribution list by the distribution list application program is illustrated by example in more detail in FIGS. 4-7 below.

The following describes an example of how the distribution list application program updates and generates a new distribution list for a particular jukebox. The distribution list application program defines relationships between elements within the system. These elements include songs, artists, or venues. As can be appreciated by one of ordinary skill in the art, other types of elements may be used depending upon where this system is implemented.

In the above embodiment, there exists a connection, that is a relationship, between any two of all of the elements (or group of elements, such as songs) within the application program. Each connection is defined by a strength value. The strength value is the sum of all weight values that apply to the two elements. The weight value is a positive or negative numerical value that varies depending upon what events have occurred between the two elements of a connection. In this embodiment, the weight value is described in tenths or hundredths, but could be a numerical value of any other order. The following are example events that receive weight values:

songs played by the same user;

songs played on the same jukebox at any given time;

songs deleted by the venue owner or jukebox operator;

songs in the top ten of the venue where the jukebox is located;

artists played by the same user;

artists played on the same jukebox at any given time but not by the same user;

artists deleted by the venue owner or jukebox operator;

artists in the top ten of the venue where the present jukebox is located;

songs or artists the system managers feel are congruous;

artists that play shows together; and

artists appearing on compilation albums.

Other events may be given weight values without departing from the scope and spirit of the present invention. In one embodiment, the distribution list application program removes songs or artists from a distribution list if their associated connection strength values are below a threshold value. Also, the distribution list application program adds songs or artists if their associated connection strength values as compiled from other jukeboxes (typically other jukeboxes in similar type venues) are above a threshold value. With only strength values used to generate and update a distribution list, large relative strength values mean the greater the likelihood the song or artist will be incorporated into other jukebox distribution lists

FIGS. 4-7 illustrate the connections of three songs A, B, Z that are stored in digital format on a particular jukebox at a venue. The following weight value rules apply in this example:

i) songs played by the same user=0.1

ii) songs played on this jukebox, but not the same user=0.05

iii) songs deleted by this venue=−0.05

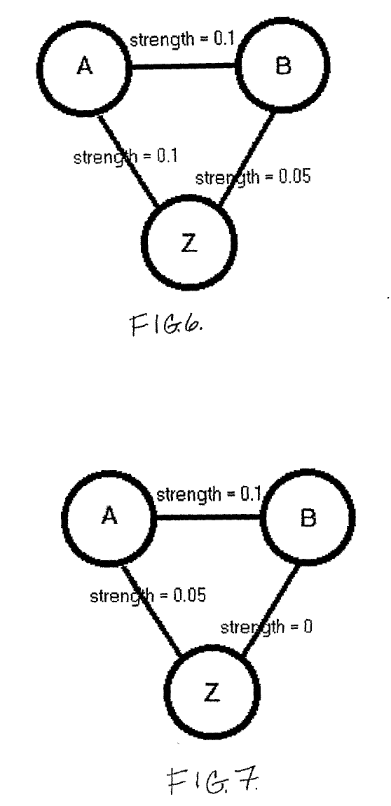

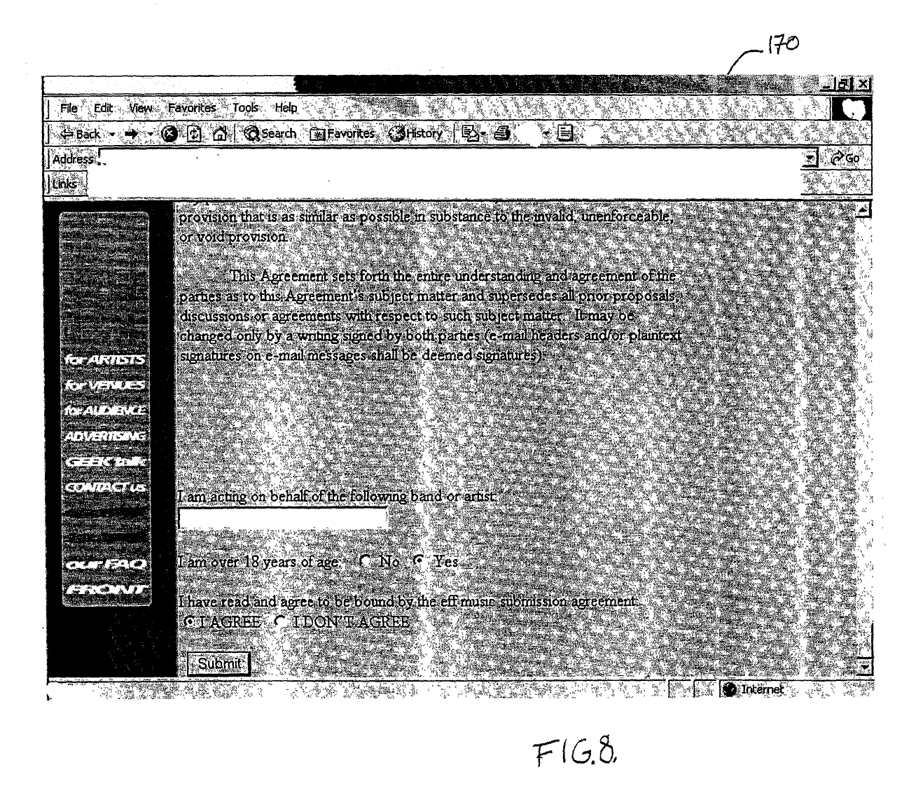

Rules for artist may also apply in this example, but are not described for clarity of the example. FIG. 4 shows the strength values of the connections that occur prior to any play of A, B, or Z on the jukebox. It will be appreciated that, because neither A nor B nor Z has been played, the strength value of all connections between A, B, and A is zero. FIG. 5 illustrates the strength values generated after a user of the jukebox puts money in the jukebox, and receives two credits, and with those two credits chooses songs A and B. Therefore, because songs A and B are played by the same user, the strength value at the connection between A and B receives a weight value of 0.1 (see rule i). The strength value of the connections between A and Z and B and Z remains zero. Following the occurrence at FIG. 5, a second user selects songs A and Z. As shown in FIG. 6, the strength value for the A, B connection remains at 0.1. The strength value for the A, Z connection is now 0.1 (rule i) and the strength value for the B, Z connection is 0.05 (rule ii), because songs B and Z were played on the same jukebox yet not played by the same user.

FIG. 7 illustrates newly calculated strength values after the venue owner decides to delete song Z from the owner's jukebox. In this example, a −0.05 value is added to the strength value of all connections to Z. The strength value of the A to Z connection is now 0.05 and the strength value of the connection between B and Z equals zero.

The distribution list application program uses the calculated connection strength values as one factor for updating the distribution lists for the present jukebox and for other jukeboxes. Other factors that go into updating a distribution list are direct requests by a venue owner or jukebox operator, a list of local artists, and a system manager's random input. If those alternate factors that go into updating a distribution list are ignored, then, for example, if another jukebox includes song B but does not include song A, then it would appear by the final calculations shown in FIG. 6 that song A would be a good song to include in a distribution list update. The update replaces another song that may have no plays or no connections with strength values greater than zero or greater than a threshold amount. Because each song belongs to an artist, the same connections, calculations, and updates can be made between artist elements as well.

FIG. 8 illustrates an agreement window 170 generated by a website application program at the server 50 that an artist 32 or label 34 first sees when signing up a band or artist using a general purpose computer that is connected to the system 24 via the network 26. The agreement window 170 presents a music submission agreement that, when approved by the artist, allows the system managers to distribute the music of the associated band or artist (hereinafter artist) to the jukeboxes 30.

Once the artist 32 or label 34 has accepted the terms of the agreement, then, as shown in FIG. 9, the person acting on behalf of the artist enters artist information, in a text area 180 of an artist information webpage 182. Artist website, phone number, and email address are also entered in predesignated areas on the artist information web page 182. The information entered on the artist information webpage 182 is made accessible to the general public 40 by the website application program. After entry of the artist information, and selection of certain login and password phrases (not shown), an artist account is created and the person acting on behalf of the artist is provided access to the account.

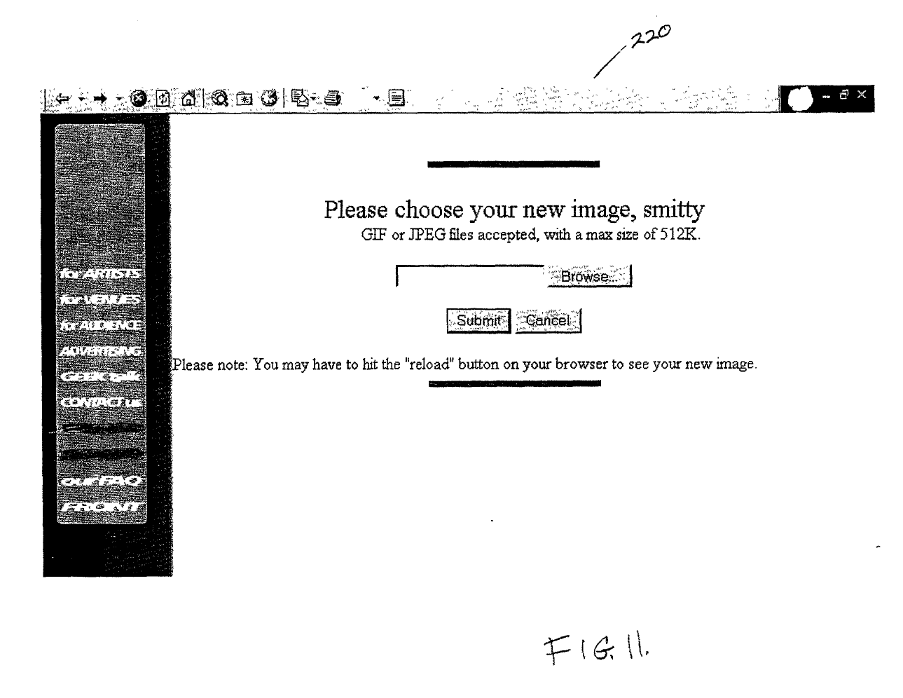

FIG. 10 illustrates an artist access webpage 188. In this non-limiting example, the webpage 188 is accessed by an artist known as “Smitty”. The webpage 188 includes an image area 190 that presents an image that is uploaded by the artist into the server 50 (see FIG. 11 below). The image presented in the image area 190 may be the image that is sent to jukeboxes with the artist's music and displayed on the jukebox user interface. Adjacent to the image area 190 is a button area 192 that includes a plurality of buttons 194-214 that allow the user to perform various functions. The buttons in the button area 192 include an upload/change image button 194, an upload a song button 196, a view song list button 200, a remove a song button 202, a view statistics button 204, a change artist info button 208, a change contact info button 212, and a change password button 214.

Upon selection of the upload/change image button 194, the person acting on behalf of the artist is presented with an upload/change image window 220 shown in FIG. 11. The upload/change image window 220 allows a user to browse their computer (local hard drive or local area network) to retrieve an image for uploading into the server 50. In one embodiment of the invention, image files in the GIF or JPEG format are preferable. However, it will be appreciated that the system 20 can be adapted to receive any of a number of different type of image formats as well as video or other media formats.

FIG. 12 illustrates an upload song window 230 that is presented after activation of the upload a song button 196. The upload song window 230 allows the person representing the artist to enter the name of a song in a name area 232 and to browse and retrieve the song associated with the entered name. Like image uploading, each song is retrieved from the user's computer (local hard drive or local area network). In this example, MP3 or WAV formatted digital music files is the preferable format for the songs. However, it will be appreciated that other types of formatted digital music and video can be provided, such as MP2, OGG, MPEG, AVI, MOV, SMIL, SWF, WMA, RMA, or PNG. It can be appreciated that the jukeboxes can play the various formatted uploaded media (video and music).

FIG. 13 illustrates a statistics window 240 that is presented to the person representing the artist upon selection of the view statistics button 204. The statistics window 240 presents various statistics of the music associated with the artist, such as number of plays of each of their songs on all jukeboxes, total number of plays of all the artist's songs on all jukeboxes, and how much money has been made based on the number of plays and the approved music submission agreement. The statistics window 240 also indicates the number of times someone selected the information button for viewing the artist information at the jukeboxes. It can be appreciated that the information included in the statistics window 240 can be provided to the person representing the artist by other means, such as mailings, or sending electronic media. It can also be appreciated that the other statistics information about a jukebox can be provided to the jukebox operator or venue owner over a network connection using a personal computer or by other means, such as mailings, or sending electronic media.

Upon selection of the view song list button 200, the user is presented with a window that shows a list of all the songs that artist has uploaded into the database 52. The user removes a song from their song list by selecting the remove a song button 202 that presents a remove a song webpage (not shown).

The change artist info button 208 allows the user to change artist info, such as the previously entered artist information, or artist website or e-mail information. The change contact info button 212 allows the user to change artist address and phone information. The change password allows the user to change their existing password.

In accordance with the present invention, a jukebox is defined as a unit for storage and/or playback of digital media.

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. A computer-based method for automatically updating a distribution list for each of a plurality of digital jukeboxes, the method comprising:
generating and storing a distribution list for each of the plurality of digital jukeboxes;
receiving feedback information from each of the plurality of digital jukeboxes over a network connection; and
automatically updating the distribution lists previously stored for each of the plurality of jukeboxes based on the received feedback information.

2. The method of claim 1, wherein the received feedback information includes values for predetermined relationships between media components stored in the jukeboxes.

3. The method of claim 2, wherein the media components comprise at least one of songs or video.

4. The method of claim 2, wherein the media components comprise at least one of audio files, video files, graphical images, or multi-media animation.

4. The method of claim 2, wherein the values for the relationships between the media components are determined according to jukebox events.

5. The method of claim 4, wherein the jukebox events include at least one of media components selected by the same user, media components selected on the same jukebox within a set period of time but not by the same user, media components canceled on a jukebox, media components deleted by the venue owner or jukebox operator, or media components that are selected a threshold number of times at the venue where the jukebox is located.

6. The method of claim 5, wherein the relationship value associated with media components selected by the same user has a first value.

7. The method of claim 5, wherein the relationship value associated with media components selected on the same jukebox within a set period of time has a second value.

8. The method of claim 5, wherein the relationship value associated with media components deleted by the venue owner or jukebox operator has a third value.

9. The method of claim 8, wherein the third value is a negative number.

10. The method of claim 1, wherein the received feedback information includes a value for predetermined relationships between each of the artists that have media components stored in the jukeboxes.

11. The method of claim 10, wherein the values for the relationships between each of the artists are determined according to jukebox events.

12. The method of claim 11, wherein the jukebox events include at least one of artists selected by the same user, artists selected on the same jukebox within a set period of time but not by the same user, artists canceled on a jukebox, artists deleted by at least one of the venue owner or jukebox operator, artists that are selected a threshold number of times at the venue where the jukebox is located, artists that perform together, and artists appearing on compilation albums.

13. The method of claim 1, further comprising sending media components to the jukebox based on the updated distribution list.

14. The method of claim 13, further comprising sending at least one of graphics, text, or video associated with the sent media components to the jukebox based on the updated distribution list.

15. The method of claim 1, further comprising providing at least a portion of the feedback information for viewing by one or more artists, venue owners, and jukebox operators.

16. The method of claim 1, wherein providing at least a portion of the feedback information for viewing comprises providing at least a portion of the feedback information for viewing at a remote computer over a network connection.

17. The method of claim 1, further comprising determining artist compensation based on the feedback information received from the plurality of digital jukeboxes.

18. A system for automatically updating a distribution list for a plurality of digital jukeboxes coupled to the system over a network, the system comprising:
a distribution list generating and storing means for generating and storing a distribution list for each of the plurality of jukeboxes;
a feedback means for receiving feedback information for each of the plurality of jukeboxes; and
an update means for automatically updating the distribution list previously stored for each of the plurality of jukeboxes based on the received feedback information.

19. The system of claim 18, wherein the received feedback information includes a value for the relationships between media components stored in the plurality of jukeboxes.

21. The method of claim 20, wherein the media components comprise at least one of audio files, video files, graphical images, or multi-media animation.

20. The system of claim 19, wherein the values for the relationships between the media components are determined according to jukebox events.

21. The system of claim 20, wherein the jukebox events include at least one of media components selected by the same user, media components selected on the same jukebox within a set period of time but not by the same user, media components canceled on a jukebox, media components deleted by the venue owner or jukebox operator, or media components that are selected a threshold number of times at the venue where the jukebox is located.

22. The system of claim 21, wherein the relationship value associated with media components selected by the same user has a first value.

23. The system of claim 21, wherein the relationship value associated with media components selected on the same jukebox within a set period of time has a second value.

24. The system of claim 21, wherein the relationship value associated with media components deleted by the venue owner or jukebox operator has a third value.

25. The system of claim 24, wherein the third value is a negative number.

26. The system of claim 18, wherein the received feedback information includes a value for the relationships between each of the artists that have media components stored in the jukebox.

27. The system of claim 26, wherein the value for the relationships between each of the artists are determined according to jukebox events.

28. The system of claim 27, wherein the jukebox events include at least one of artists selected by the same user, artists selected on the same jukebox within a set period of time but not by the same user, artists canceled on a jukebox, artists deleted by at least one of the venue owner or jukebox operator, artists that are selected a threshold number of times at the venue where the jukebox is located, artists that perform together, and artists appearing on compilation albums.

29. The system of claim 18, further comprising a media components distribution means for sending music to the jukebox based on the updated distribution list.

30. The system of claim 18, further comprising a graphics distribution means for sending at least one of graphics, text, or video associated with the sent media components to the jukebox based on the updated distribution list.

31. The system of claim 18, further comprising a media distribution means for sending media components to the jukebox based on the updated distribution list.

32. The system of claim 31, further comprising a media entering means for entering media components and associated media files into the system and for making the entered media components and associated media files available for the media distribution means.

33. The system of claim 32, wherein the media entering means includes a receiving device for receiving media components and associated media files from a remote location over the network.

34. The system of claim 33, wherein the media files are formatted in at least one of a WAV, MP3, MP2, OGG, MPEG, AVI, MOV, SMIL, SWF, WMA, RMA, JPEG, PNG, or GIF file format.

35. The system of claim 33, wherein the associated media files are formatted in at least one of a JPEG, PNG, or GIF file format.

36. The system of claim 18, further comprising a web page means for generating a web page accessible by a computer coupled to the system via a network connection, the web page includes at least a portion of the feedback information.

37. The system of claim 18, further comprising determining artist compensation based on the feedback information received from the plurality of digital jukeboxes.
